(19) United States
(12) Patent Application Publication
(10) Pub. No.: US 2005/0111139 A1
(43) Pub. Date: May 26, 2005

(54) Magnetic recording/reproducing apparatus

(76) Inventors: Yasuhiko Shinjo, Atsugi-Shi (JP); Ryoichi Annen, Atsugi-Shi (JP); Kazuhide Murase, Atsugi-Shi (JP)

Correspondence Address: LADAS & PARRY LLP, 224 SOUTH MICHIGAN AVENUE, SUITE 1200, CHICAGO, IL, 60604, US

(21) Appl. No.: 10/931,177

(22) Filed: Aug. 31, 2004

(30) Foreign Application Priority Data
Nov. 26, 2003 (JP) 2003-395764

(51) Int. Cl. G11B 15/00

(52) U.S. Cl. 360/130.23

(57) ABSTRACT

A magnetic recording/reproducing apparatus includes a rotary drum apparatus for rotating a rotary drum with a magnetic head and contacting the magnetic head to a first magnetic tape with a first tape width and a second magnetic tape with a second tape width, the rotary drum apparatus including the rotary drum situated at a lower part thereof and a fixed drum situated at an upper part thereof, the fixed drum having a tape guide groove for positionally restricting an upper side edge part of the first magnetic tape and an upper side edge part of the second magnetic tape, and first and second guide members for selectively guiding the first and second magnetic tapes, wherein the first guide members are configured to positionally restrict a lower side edge part of the first magnetic tape, and the second guide members are configured to positionally restrict a lower side edge part of the second magnetic tape.

### BACKGROUND OF THE INVENTION

1. Field of the Invention

The present invention generally relates to a magnetic recording/reproducing apparatus, and more particularly to a magnetic recording/reproducing apparatus that can be mounted with magnetic tapes of various tape widths.

2. Description of the Related Art

As a conventional magnetic recording/reproducing apparatus used as a recording unit of a computer, there is, for example, a streamer apparatus which contacts a magnetic tape to a rotary drum apparatus, and magnetically records/reproduces information with a helical scanning method (e.g. Japanese Laid-Open Patent Application No.2003-203317).

This type of magnetic recording/reproducing apparatus includes a rotary drum apparatus for performing a recording/reproducing process on a magnetic tape, and a tape loading mechanism for contacting a magnetic tape to the rotary drum apparatus. The rotary drum apparatus has a rotary drum (also referred to as “upper drum”) with plural magnetic drums attached thereto, and a fixed drum (also referred to as “lower drum”) fixed on a chassis.

The fixed drum is fixed to a base (chassis) of the magnetic recording/reproducing apparatus, and the rotary drum is disposed concentrically to the fixed drum. The rotary drum is rotated at high speed with a motor. The rotation causes the magnetic heads provided to the rotary drum to also rotate. This enables a magnetic recording/reproducing process using a helical scanning method to be performed on a magnetic tape contacting to the rotary drum apparatus.

The tape loading mechanism includes, for example, a guiding pole, and/or a tilt pole. The tape loading mechanism pulls out a magnetic tape from the tape cartridge having the magnetic tape installed therein, and contacting the magnetic tape to the rotary drum apparatus at a predetermined angle.

In a magnetic recording/reproducing process, a satisfactory recording/reproducing performance cannot be attained unless the magnetic tape is disposed at a constant scanning position. Therefore, in the conventional magnetic recording/reproducing apparatus, a magnetic tape is steadily scanned by restricting the positions of an upper side edge part and a lower side edge part of the magnetic tape. More specifically, in the conventional magnetic recording/reproducing apparatus, the position of the lower side edge part of the magnetic tape is restricted with the fixed drum, and the upper side edge part of the magnetic tape is restricted with a position restriction flange.

Along with the recent computers provided with higher density and larger capacity memory computers, there is a growing demand for enlarging the memory capacity of a streamer apparatus (magnetic recording/reproducing apparatus) which is connected to a computer for backing up data, for example. One method of satisfying such demand is to narrow the pitch. However, merely narrowing the pitch is insufficient for satisfying such demand. Accordingly, another method in which the width of the magnetic tape is widened is proposed.

Conventionally, however, in using both the magnetic tape with the widened width (hereinafter referred to as wide width magnetic tape) and the magnetic tape with a narrow width (hereinafter referred to as narrow width magnetic tape), separate types of magnetic recording/reproducing apparatuses are required, in which one is used for the narrow width magnetic tape and the other is used for the wide width magnetic tape. Accordingly, there is an inconvenience of preparing two separate types of magnetic recording/reproducing apparatuses in order to perform recording/reproducing with the narrow width magnetic tape and the wide width magnetic tape. In addition, the requiring of two separate types of magnetic recording/reproducing apparatuses leads to increase in cost and loss of recording efficiency.

### SUMMARY OF THE INVENTION

It is a general object of the present invention to provide a magnetic recording/reproducing apparatus that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a magnetic recording/reproducing apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a magnetic recording/reproducing apparatus including: a rotary drum apparatus for rotating a rotary drum with a magnetic head and contacting the magnetic head to a first magnetic tape with a first tape width and a second magnetic tape with a second tape width, the rotary drum apparatus including the rotary drum situated at a lower part thereof and a fixed drum situated at an upper part thereof, the fixed drum having a tape guide groove for positionally restricting an upper side edge part of the first magnetic tape and an upper side edge part of the second magnetic tape; and first and second guide members for selectively guiding the first and second magnetic tapes; wherein the first guide members are configured to positionally restrict a lower side edge part of the first magnetic tape, and the second guide members are configured to positionally restrict a lower side edge part of the second magnetic tape.

Furthermore, the present invention provides a magnetic recording/reproducing apparatus including: a rotary drum apparatus situated on a base for rotating a rotary drum with a magnetic head and contacting the magnetic head to a first magnetic tape with a first tape width and a second magnetic tape with a second tape width, the rotary drum apparatus including the rotary drum and a fixed drum having a tape guide groove, the tape guide groove being configured to positionally restrict a lower side edge part of the first magnetic tape and a lower side edge part of the second magnetic tape; guide members for guiding the first and second magnetic tapes, the guide members being configured to positionally restrict an upper side edge part of the first magnetic tape and an upper side edge part of the second magnetic tape; and a drum elevation mechanism for raising and lowering the rotary drum apparatus with respect to the base.

In the magnetic recording/reproducing apparatus according to an embodiment of the present invention, the drum elevation mechanism may raise and lower the rotary drum apparatus within a first positional range corresponding to the first tape width and within a second positional range corresponding to the second tape width.

In the magnetic recording/reproducing apparatus according to an embodiment of the present invention, the drum elevation mechanism may raise and lower the rotary drum apparatus to a position allowing the upper side edge part of the first magnetic tape and the upper side edge part of the second magnetic tape to be constantly situated at a same height with respect to the base.

Furthermore, the present invention provides a magnetic recording/reproducing apparatus including: a rotary drum apparatus situated on a base for rotating a rotary drum with a magnetic head and contacting the magnetic head to a first magnetic tape with a first tape width and a second magnetic tape with a second tape width, the rotary drum apparatus including the rotary drum and a fixed drum having a tape guide groove, the tape guide groove being configured to positionally restrict a lower side edge part of the first magnetic tape and a lower side edge part of the second magnetic tape; guide members for guiding the first and second magnetic tapes, the guide members being configured to positionally restrict an upper side edge part of the first magnetic tape and an upper side edge part of the second magnetic tape; and a guide elevation mechanism for raising and lowering the guide members with respect to the base.

In the magnetic recording/reproducing apparatus according to an embodiment of the present invention, the guide elevation mechanism may raise and lower the guide members within a first positional range corresponding to the first tape width and within a second positional range corresponding to the second tape width.

Other objects and further features of the present invention will be apparent from the following detailed description when read in conjunction with the accompanying drawings.

### BRIEF DESCRIPTION OF THE DRAWINGS

FIG. 1 is a schematic view of a magnetic recording/reproducing apparatus according to a first embodiment of the present invention, in which a wide width tape is shown in a wound state;

FIG. 2 is a schematic view of a magnetic recording/reproducing apparatus according to a first embodiment of the present invention, in which a narrow width tape is shown in a wound state;

FIG. 3 is a schematic view of a magnetic recording/reproducing apparatus according to a second embodiment of the present invention, in which a wide width tape is shown in a wound state;

FIG. 4 is a schematic view of a magnetic recording/reproducing apparatus according to a second embodiment of the present invention, in which a narrow width tape is shown in a wound state;

FIG. 5 is a schematic view of a magnetic recording/reproducing apparatus according to a third embodiment of the present invention, in which a wide width tape is shown in a wound state; and

FIG. 6 is a schematic view of a magnetic recording/reproducing apparatus according to a third embodiment of the present invention, in which a narrow width tape is shown in a wound state.

### DESCRIPTION OF THE PREFERRED EMBODIMENTS

In the following, embodiments of the present invention are described with reference to the accompanying drawings.

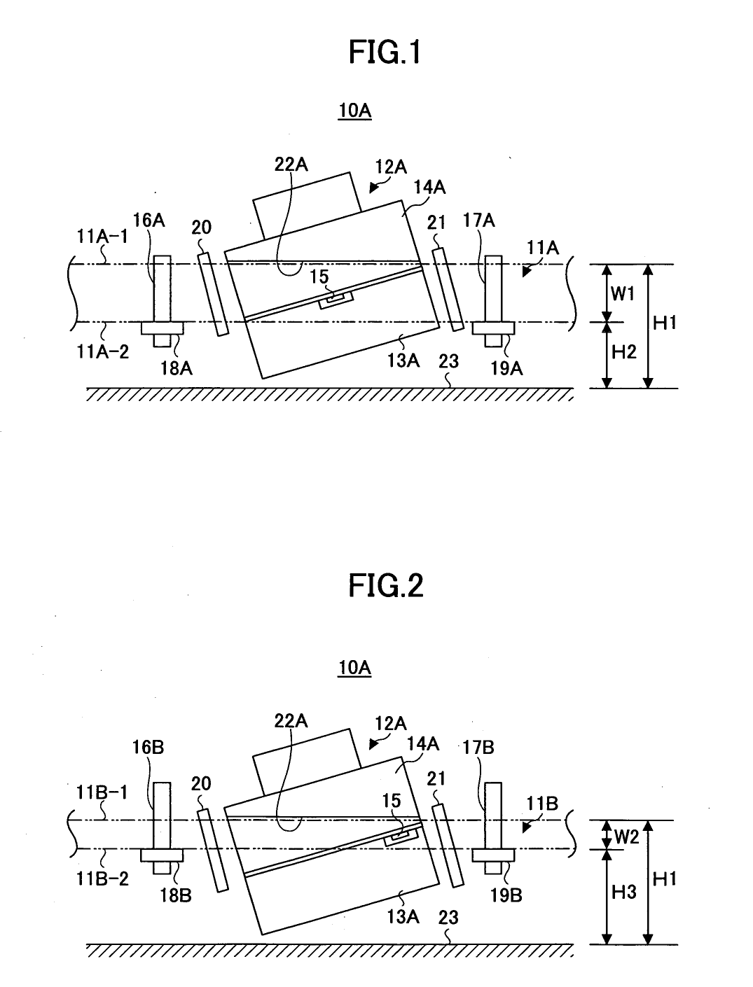

FIGS. 1 and 2 show an exemplary configuration of a magnetic recording/reproducing apparatus 10A according to the first embodiment of the present invention. The magnetic recording/reproducing apparatus 10A is, for example, used for a memory unit of a computer, and configured to magnetically record/reproduce information with respect to magnetic tapes 11A, 11B by using a helical scanning method (technique).

It is to be noted that the magnetic recording/reproducing apparatus 10A is configured to be able to mount both a magnetic tape having a wide tape width (as shown with arrow W1 in FIG. 1) (hereinafter referred to as wide width magnetic tape 11A) and a magnetic tape having a narrow tape width (as shown with arrow W2 in FIG. 2) (hereinafter referred to as narrow width magnetic tape 11B), and to perform a magnetic recording/reproducing process to both of the tapes.

The magnetic recording/reproducing apparatus 10A includes a rotary drum apparatus 12A for performing a magnetic recording/reproducing process on the magnetic tapes 11A, 11B, and a guide rollers 16A, 16B, 17A, 17B, which form part of the tape loading mechanism. The rotary drum apparatus 12A includes a rotary drum 13A having plural magnetic heads 15 attached thereto, and a fixed drum 14A fixed to a base 23 (chassis of the magnetic recording/reproducing apparatus 10A) by using a fixing holder (not shown).

The fixed drum 14A contacts to upper side edge parts 11A, 11B of the magnetic tapes 11A, 11B, respectively, and is provided with a tape guide groove 22A for guiding the scanning of the tapes 11A, 11B. Furthermore, the rotary drum 13A is coaxially disposed with respect to the fixed drum 14A, and is rotated by a motor (not shown) in high speed to a predetermined rotation count. Accordingly, a magnetic head 15 provided to the rotary drum 13A is rotated. This enables a magnetic recording/reproducing process using a helical scanning method to be performed on the magnetic tapes 11A, 11B contacted to the rotary drum apparatus 12A.

Regarding the positional relation between the rotary drum 13A and the fixed drum 14A of the rotary drum apparatus 12A according to the first embodiment of the present invention, the rotary drum apparatus 12A has the fixed drum 14A situated at its upper portion above the rotary drum 13A. Accordingly, the tape guide groove 22A provided to the fixed drum 14A restricts the position of the upper side edge parts 11A-1, 11B-1 of the magnetic tapes 11A, 11B.

Meanwhile, the guide rollers 16A, 16B, 17A, 17B, and the tilt poles 20, 21 form part of the tape loading mechanism. The tape loading mechanism serves to pull out the magnetic tape 11A, 11B from a tape cartridge (not shown), and contacts the magnetic tape 11A, 11B to the rotary drum apparatus 12A at a predetermined angle.

The guide rollers 16A, 16B, 17A, 17B, serve to restrict mainly the scanning position of the magnetic tape 11A, 11B with the position restriction flanges 18A, 18B, 19A, 19B. The tilt poles 20, 21 are disposed with a predetermined tilt angle, and serve to allow the magnetic tape 11A, 11B to smoothly contact and/or separate to/from the cylindrical rotary drum apparatus 12A.

Among the four guide rollers 16A, 16B, 17A, and 17B, the guide rollers 16A and 17A correspond to the wide width magnetic tape 11A (see FIG. 1), and the guide rollers 16B and 17B correspond to the narrow width magnetic tape 11B (see FIG. 2). In the guide rollers 16A, 17A and the guide rollers 16B, 17B, the height of the position restriction flanges 18A, 19A and the position restriction flanges 18B 19B are different with respect to the base 23.

More specifically, the position restriction flanges 18A, 19A, which are provided to the guide rollers 16A, 17A corresponding to the wide width magnetic tape 11A, are configured to contact a lower side edge part 11A-2 of the wide width magnetic tape 11A. On the other hand, the position restriction flanges 18B, 19B, which are provided to the guide rollers 16B,17B corresponding to the narrow width magnetic tape 11B, are configured to contact a lower side edge part 11B-2 of the narrow width edge part 11B-2.

The height from the base 23 to the upper faces of the position restriction flanges 18A, 19A (hereinafter referred to as “height H2”) is set to be shorter than the height from the base to the upper faces of the position restriction flanges 18B, 19B (hereinafter referred to as “height H3”), that is, to satisfy a relation of H2<H3. In this state, however, the height from the base 23 to the tape guide groove 22A of the fixed drum 14A (hereinafter referred to as “height H1”) remains the same (constant) whether the wide width magnetic tape 11A or the narrow width magnetic tape 11B is employed since the rotary drum apparatus 12A is fixed to the base 23.

The guide rollers 16A, 17A and the guide rollers 16B, 17B are configured to switchably (selectively) contact to a magnetic tape in accordance with the tape width of the magnetic tape (magnetic tapes 11A and 11B) mounted to the magnetic recording/reproducing apparatus 10A. The tape width of the magnetic tape can be detected, for example, by detecting the actual tape width of the mounted magnetic tape 11A, 11B, or by detecting the shape of the tape cartridge having the magnetic tape 11A, 11B installed therein. The selectively switching between the guide rollers 16A, 17A, and 16B, 17B can be executed, for example, by using an actuator.

Thus structured, in a case where the wide width magnetic tape 11A is contacted to the rotary drum apparatus 12A, the position of the upper side edge part 11A-1 is restricted by the tape guide groove 22A of the fixed drum 14A, and the position of the lower side edge part 11A-2 is restricted by the position restriction flanges 18A, 19A of the guide rollers 16A, 17A. In a case where the narrow width magnetic tape 11B is contacted to the rotary drum apparatus 12A, the position of the upper side edge part 11B-1 is restricted by the tape guide groove 22A of the fixed drum 14A, and the position of the lower side edge part 11B-2 is restricted by the position restriction flanges 18B, 19B of the guide rollers 16B, 17B.

Accordingly, whether the wide width magnetic tape 11A or the narrow width magnetic tape 11B is mounted to the magnetic recording/reproducing apparatus 10A, magnetic tapes 11A, 11B can be scanned in precisely positioned state. Hence, a steady magnetic recording/reproducing process can be performed for the magnetic tapes having different tape widths 11A, 11B.

Furthermore, since two types of magnetic tapes (wide width magnetic tape 11A and narrow width magnetic tape 11B) can be used for the magnetic recording/reproducing apparatus 10A according to the first embodiment of the present invention, applicability and convenience of the magnetic recording/reproducing apparatus 10A can be improved.

Furthermore, since the magnetic recording/reproducing apparatus 10A according to the first embodiment of the present invention is configured to position the upper side edge part 11A-1 of the magnetic tape 11A and the upper side edge part 11B-1 of the magnetic tape 11B to a same height with respect to the base 23 (height H1), the magnetic recording/reproducing apparatus 10A is able to mount tape cartridges with tapes of different tape width W1, W2 in a state where the upper faces of the cartridges positioned with the same height, to thereby enable size-reduction (thin-sizing) of the magnetic recording/reproducing apparatus 10A. This owes to the reasons described below.

The magnetic tapes 11A, 11B installed inside respective tape cartridges are pulled out from the tape cartridges (tape loading) and contacted to the rotary drum apparatus 12A in a predetermined angle. In tape loading the magnetic tapes 11A, 11B, parts including, for example, the guide rollers 16A, 16B, 17A, 17B are inserted in the tape cartridges on the back side of the magnetic tapes 11A, 11B, and are moved from such position when the magnetic tapes 11A, 11B are pulled out from the cartridges.

In this process, as described above, the upper side edge parts 11A-1, 11B-1 of the magnetic tapes 11A, 11B with different tape width are constantly disposed at a position of the same height (H1) by the tape guide groove 22A provided to the fixed drum 14A.

In a case supposing that the magnetic recording/reproducing apparatus 10A is configured to constantly dispose the lower side edge parts 11A-2, 11B-2 of the magnetic tapes 11A, 11B at positions of the same height, the height of the upper side edge part 11A-1 and that of the upper side edge part 11B-1 with respect to the base 23 become different. This causes the cartridges in the magnetic recording/reproducing apparatus installed with the magnetic tapes 11A, 11B to have different heights (position of the upper faces of the cartridges), thereby requiring a large sized magnetic recording/reproducing apparatus for accommodating the cartridges of different height.

However, with the above-described embodiment of the present invention, the upper side edge parts 11A-1, 11B-1 of the magnetic tapes 11A, 11B with different tape width are constantly disposed at a position of the same height (H1), to thereby enable the upper faces of the cartridges installing the magnetic tapes of different tape width to be disposed at the same height. Hence, size-reduction (thin-sizing) of the magnetic recording/reproducing apparatus 10A can be accomplished.

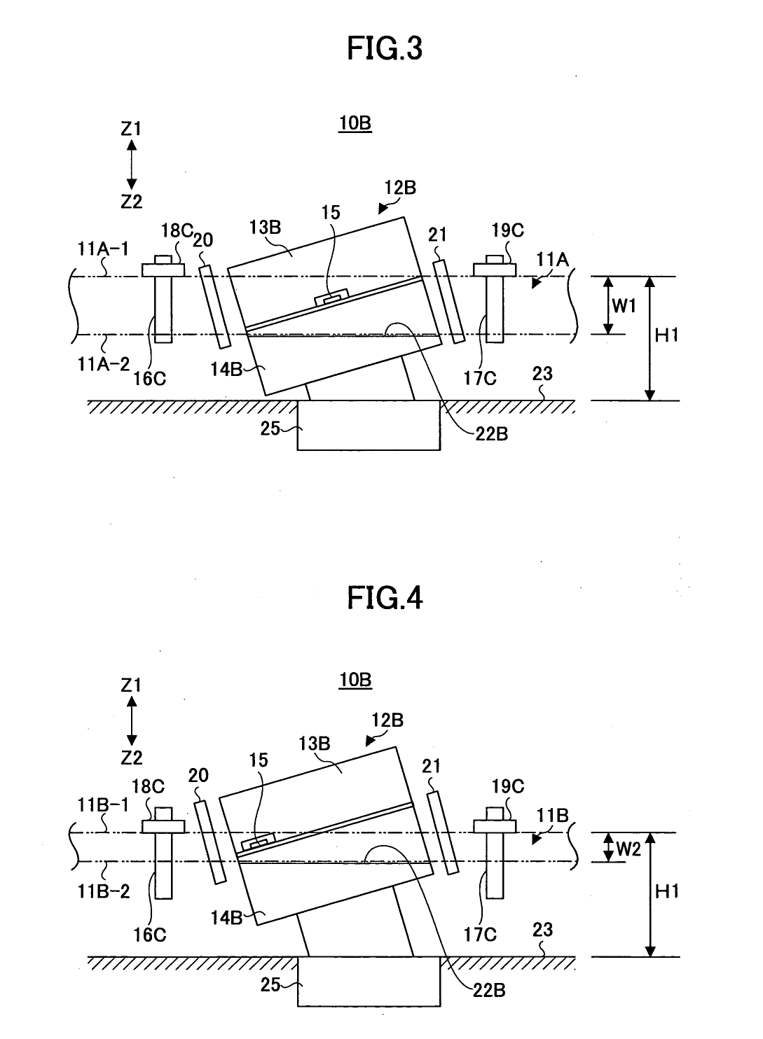

Next, a second embodiment of the present invention is described with reference to FIGS. 3 and 4, in which FIGS. 3 and 4 show a configuration of a magnetic recording/reproducing apparatus 10B according to the second embodiment of the present invention. The magnetic recording/reproducing apparatus 10B according to the second embodiment of the present invention can also be mounted with magnetic tapes of different tape widths 11A, 11B. FIG. 3 shows the wide width magnetic tape 11A mounted to the magnetic recording/reproducing apparatus 10B, and FIG. 4 shows the narrow width magnetic tape 11B mounted to the magnetic recording/reproducing apparatus 10B.

In FIGS. 3 and 4, like components are denoted by like numerals as of FIGS. 1 and 2 in the first embodiment of the present invention, and will not be further explained.

A rotary drum apparatus 12B provided to the magnetic recording/reproducing apparatus 10B has a fixed drum 14B disposed at its lower side (the side toward the base 23), and a rotary drum 13B disposed at an upper part of the fixed drum 14B. The guide rollers 16C, 17C are formed with position restriction flanges 18C, 19C at upper portions thereof.

Accordingly, the positions of the upper side edge parts 11A-1, 11B-1 of the respective magnetic tapes 11A, 11B are restricted by the guide rollers 16C, 17C (position restriction flanges 18C, 19C), and the positions of the lower side edge parts 11A-2, 11B-2 are restricted by a tape guide groove 22B formed in the fixed drum 14B. Accordingly, in the second embodiment of the present invention, whether the wide width magnetic tape 11A or the narrow width magnetic tape 11B is mounted to the magnetic recording/reproducing apparatus 10B, magnetic tapes 11A, 11B can be scanned in precisely positioned state. Hence, a steady magnetic recording/reproducing process can be performed for the magnetic tapes having different tape widths 11A, 11B.

Here, in the second embodiment of the present invention, a drum elevation mechanism 25 is provided to a lower part of the rotary drum apparatus 12B. The drum elevation mechanism 25 is fixed to the base 23, and raises and lowers (elevator movement) the rotary drum apparatus 12B in directions Z1 and Z2 as shown in FIGS. 3 and 4. By providing the drum elevation mechanism 25 configured to raise and lower the rotary drum apparatus 12B, the magnetic tapes having different tape widths 11A, 11B can be mounted to the magnetic recording/reproducing apparatus 10B. It is to be noted that although the rotary drum apparatus 12B is raised and lowered, the position of the position restriction flanges 18C, 19C is disposed at a position with a fixed height (arrow H1 in FIGS. 3 and 4).

When the tape width of the mounted magnetic tape 11A, 11B is detected (e.g. by directly detecting the magnetic tape or by detecting the tape cartridge), the drum elevation mechanism 25 raises or lowers the rotary drum apparatus 12B to a height corresponding to the mounted magnetic tape 11A, 11B.

More specifically, in a case where the wide width magnetic tape 11A is mounted as shown in FIG. 3, the drum elevation mechanism 25 lowers the rotary drum apparatus 12B in an arrow direction Z2 so that the distance between the position restriction flange 18C, 19C and the tape guide groove 22B becomes a tape width of W1. In a case where the narrow width magnetic tape 11b is mounted as shown in FIG. 4, the drum elevation mechanism 25 raises the rotary drum apparatus 12B in an arrow direction Z1 so that the distance between the position restriction flange 18C, 19C and the tape guide groove 22B becomes a tape width of W2.

Accordingly, the magnetic recording/reproducing apparatus 10B according to the second embodiment of the present invention is also able to mount two types of magnetic tapes with different tape width (wide width magnetic tape 11A and narrow width magnetic tape 11B). Therefore, applicability and convenience of the magnetic recording/reproducing apparatus 10B can be improved. Furthermore, since the magnetic recording/reproducing apparatus 10B is configured to position the upper side edge part 11A-1 of the magnetic tape 11A and the upper side edge part 11B-1 of the magnetic tape 11B to a same height with respect to the base 23 (height H1), size-reduction (thin-sizing) of the magnetic recording/reproducing apparatus 10B can be achieved.

Although the magnetic recording/reproducing apparatus 10B shown in the second embodiment of the present invention is applied to two types of magnetic tapes (wide width magnetic tape 11A having the tape width W1 and narrow width magnetic tape 11B having the tape width W2), the magnetic recording/reproducing apparatus 10B can be applied to many other magnetic tapes having various tape widths may be applied since the drum elevation mechanism 25 is able to disposed the rotary drum apparatus 12B at a desired height.

In addition, the magnetic recording/reproducing apparatus 10A shown in the first embodiment of the present invention uses different guide rollers depending on the magnetic tapes with different tape widths. More specifically, the magnetic recording/reproducing apparatus 10A shown in the first embodiment of the present invention uses a total of four guide rollers, that is, the guide rollers 16A, 17A for the wide width magnetic tape 11A and the guide rollers 16B, 17B for the narrow width magnetic tape 11B. However, the magnetic recording/reproducing apparatus 10B shown in the second embodiment of the present invention uses fewer components since the magnetic recording/reproducing apparatus 10B shown in the second embodiment of the present invention uses only two guide rollers 16C, 17C for guiding the magnetic tape, regardless of its tape width, thereby reducing the amount of required components.

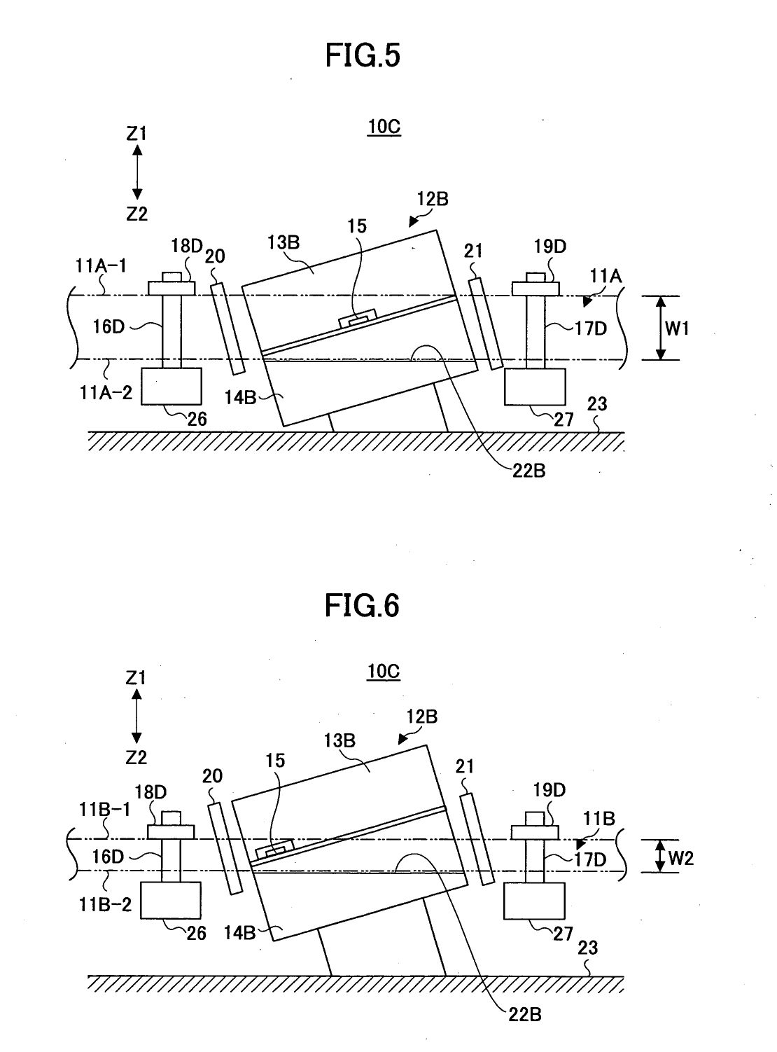

Next, a third embodiment of the present invention is described with reference to FIGS. 5 and 6, in which FIGS. 5 and 6 show a configuration of a magnetic recording/reproducing apparatus 10C according to the third embodiment of the present invention. The magnetic recording/reproducing apparatus 10C according to the third embodiment of the present invention can also be mounted with magnetic tapes of different tape widths 11A, 11B. FIG. 5 shows the wide width magnetic tape 11A mounted to the magnetic recording/reproducing apparatus 10C, and FIG. 6 shows the narrow width magnetic tape 11B mounted to the magnetic recording/reproducing apparatus 10C. In FIGS. 5 and 6, like components are denoted by like numerals as of FIGS. 1, 2, 3, 4 in the first and second embodiments of the present invention, and will not be further explained.

The above-described magnetic recording/reproducing apparatus 10B according to the second embodiment of the present invention is provided with the drum elevation mechanism 25 for raising and lowering the rotary drum apparatus 12B. Here, the magnetic recording/reproducing apparatus 10C according to the third embodiment of the present invention is provided with guide roller elevation mechanisms (guide elevation mechanism) 26, 27 for raising and lowering guide rollers 16D, 17D in the arrow directions Z1, Z2 shown in FIGS. 5 and 6.

Similar to the second embodiment of the present invention, the rotary drum apparatus 12B provided to the magnetic recording/reproducing apparatus 10C has the fixed drum 14B disposed at its lower side (the side toward the base 23), and the rotary drum 13B disposed at the upper part of the fixed drum 14B. In addition, the guide rollers 16D, 17D are formed with position restriction flanges 18D, 19D at upper portions thereof.

Accordingly, the positions of the upper side edge parts 11A-1, 11B-1 of the respective magnetic tapes 11A, 11B are restricted by the guide rollers 16D, 17D (position restriction flanges 18D, 19D), and the positions of the lower side edge parts 11A-2, 11B-2 are restricted by a tape guide groove 22B formed in the fixed drum 14B. Accordingly, in the third embodiment of the present invention, whether the wide width magnetic tape 11A or the narrow width magnetic tape 11B is mounted to the magnetic recording/reproducing apparatus 10C, magnetic tapes 11A, 11B can be scanned in precisely positioned state. Hence, a steady magnetic recording/reproducing process can be performed for the magnetic tapes having different tape widths 11A, 11B.

As described above, the magnetic recording/reproducing apparatus 10C according to the third embodiment of the present invention is provided with the guide roller elevation mechanisms 26, 27 for raising and lowering the guide rollers 16D, 17D. The guide roller elevation mechanisms 26, 27 are fixed to the base 23 by a fixed holder (not shown). Accordingly, the guide roller elevation mechanisms 26, 27 raise and lower the guide rollers 16D, 17D with respect to the base 23 (arrow directions Z1, Z2 in FIGS. 5 and 6). By providing the guide roller elevation mechanisms 26, 27 configured to raise and lower the guide rollers 16D, 17D, the magnetic tapes having different tape widths 11A, 11B can be mounted to the magnetic recording/reproducing apparatus 10C.

When the tape width of the mounted magnetic tape 11A, 11B is detected (e.g. by directly detecting the magnetic tape or by detecting the tape cartridge), the guide roller elevation mechanisms 26, 27 raises or lowers the guide rollers 16D, 17D to a height corresponding to the mounted magnetic tape 11A, 11B.

More specifically, in a case where the wide width magnetic tape 11A is mounted as shown in FIG. 5, the guide roller elevation mechanisms 26, 27 raises the guide rollers 16D, 17D in the arrow direction Z1 so that the distance between the position restriction flange 18D, 19D and the tape guide groove 22B becomes a tape width of W1. In a case where the narrow width magnetic tape 11B is mounted as shown in FIG. 6, the guide roller elevation mechanisms 26, 27 lowers the guide rollers 16D, 17D in the arrow direction Z2 so that the distance between the position restriction flange 18D, 19D and the tape guide groove 22B becomes a tape width of W2.

Accordingly, the magnetic recording/reproducing apparatus 10C according to the third embodiment of the present invention is also able to mount two types of magnetic tapes with different tape width (wide width magnetic tape 11A and narrow width magnetic tape 11B). Therefore, applicability and convenience of the magnetic recording/reproducing apparatus 10C can be improved.

Although the magnetic recording/reproducing apparatus 10C shown in the third embodiment of the present invention is applied to two types of magnetic tapes (wide width magnetic tape 11A having the tape width W1 and narrow width magnetic tape 11B having the tape width W2), the magnetic recording/reproducing apparatus 10C can be applied to many other magnetic tapes having various tape widths since the guide roller elevation mechanisms 26, 27 are able to dispose the guide rollers 16D, 17D at a desired height. Furthermore, similar to the second embodiment of the present invention, the magnetic recording/reproducing apparatus 10C according to the third embodiment of the present invention also uses fewer components since the magnetic recording/reproducing apparatus 10C uses only two guide rollers 16D, 17D for guiding the magnetic tape, regardless of its tape width. Thereby the amount of required components can be reduced.

Further, the present invention is not limited to these embodiments, but various variations and modifications may be made without departing from the scope of the present invention.

The present application is based on Japanese Priority Application No.2003-395764 filed on Nov. 26, 2003, with the Japanese Patent Office, the entire contents of which are hereby incorporated by reference.

1. A magnetic recording/reproducing apparatus comprising:
a rotary drum apparatus for rotating a rotary drum with a magnetic head and contacting the magnetic head to a first magnetic tape with a first tape width and a second magnetic tape with a second tape width, the rotary drum apparatus including the rotary drum situated at a lower part thereof and a fixed drum situated at an upper part thereof, the fixed drum having a tape guide groove for positionally restricting an upper side edge part of the first magnetic tape and an upper side edge part of the second magnetic tape; and
first and second guide members for selectively guiding the first and second magnetic tapes;
wherein the first guide members are configured to positionally restrict a lower side edge part of the first magnetic tape, and the second guide members are configured to positionally restrict a lower side edge part of the second magnetic tape.

2. A magnetic recording/reproducing apparatus comprising:
a rotary drum apparatus situated on a base for rotating a rotary drum with a magnetic head and contacting the magnetic head to a first magnetic tape with a first tape width and a second magnetic tape with a second tape width, the rotary drum apparatus including the rotary drum and a fixed drum having a tape guide groove, the tape guide groove being configured to positionally restrict a lower side edge part of the first magnetic tape and a lower side edge part of the second magnetic tape;
guide members for guiding the first and second magnetic tapes, the guide members being configured to positionally restrict an upper side edge part of the first magnetic tape and an upper side edge part of the second magnetic tape; and
a drum elevation mechanism for raising and lowering the rotary drum apparatus with respect to the base.

3. The magnetic recording/reproducing apparatus as claimed in claim 2, wherein the drum elevation mechanism raises and lowers the rotary drum apparatus within a first positional range corresponding to the first tape width and within a second positional range corresponding to the second tape width.

4. The magnetic recording/reproducing apparatus as claimed in claim 2, wherein the drum elevation mechanism raises and lowers the rotary drum apparatus to a position allowing the upper side edge part of the first magnetic tape and the upper side edge part of the second magnetic tape to be constantly situated at a same height with respect to the base.

5. A magnetic recording/reproducing apparatus comprising:
a rotary drum apparatus situated on a base for rotating a rotary drum with a magnetic head and contacting the magnetic head to a first magnetic tape with a first tape width and a second magnetic tape with a second tape width, the rotary drum apparatus including the rotary drum and a fixed drum having a tape guide groove, the tape guide groove being configured to positionally restrict a lower side edge part of the first magnetic tape and a lower side edge part of the second magnetic tape;
guide members for guiding the first and second magnetic tapes, the guide members being configured to positionally restrict an upper side edge part of the first magnetic tape and an upper side edge part of the second magnetic tape; and
a guide elevation mechanism for raising and lowering the guide members with respect to the base.

6. The magnetic recording/reproducing apparatus as claimed in claim 5, wherein the guide elevation mechanism raises and lowers the guide members within a first positional range corresponding to the first tape width and within a second positional range corresponding to the second tape width.
